(19) United States
(12) Patent Application Publication
(10) Pub. No.: US 2004/0055012 A1
(43) Pub. Date: Mar. 18, 2004

(54) Content advisory rating preservation during personal video recorder trick play modes

(76) Inventors: Bridget Kimball, Encinitas, CA (US); Glen Peter Goffin, Dublin, PA (US); Paul Baker, San Diego, CA (US); Greg McDonald, San Diego, CA (US); Walter Anderes, San Diego, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/243,151

(22) Filed: Sep. 13, 2002

(51) Int. Cl. H04N 7/16; H04N 7/173

(52) U.S. Cl. 725/88; 725/102; 725/90; 725/28

(57) ABSTRACT

A personal video recorder records and plays back a television program in a user-defined playback mode while preserving content advisory rating information. A decoder parses a digital transport stream comprising transport stream packets containing the television program and generates navigation data. A source of content advisory rating information corresponding to said television program is provided. This source of content advisory rating information may be within the digital transport stream. A non-volatile storage unit is used for saving each of the frames of the television program in a transport stream file and for saving the navigation data in a navigation data file. The navigation data includes pointers that point to a location of each of the frames of the television program in the transport stream file and content advisory rating information associated with each of the frames from the source of content advisory rating information. A processor for executes an algorithm that processes the transport stream file according to the user-defined playback mode. Content advisory rating information that corresponds to frames that are to be shown in the user-defined playback mode is taken from the navigation data file and inserted in the video output signal.

### FIELD OF THE INVENTION

The present invention relates to the field of recording and replaying a television program that contains content advisory rating information with a personal video recorder that is capable of trick play mode operation.

### BACKGROUND OF THE INVENTION

Concern about inappropriate content for children on television is almost as old as the medium itself. As a result of this concern, manufacturers of television receivers are required in many instances by law to equip television sets and other video receivers, such as set top boxes (STBs), integrated receiver descramblers (IRDs), and personal video recorders (PVRs), with a parental control device, often referred to as a V-chip. This parental control device allows a parent or guardian to automatically block television programming that contains material considered to be in appropriate, such as, sexually explicit material, violence, profanity, etc.

Many parental control devices rely on content advisory ratings that accompany television programs, movies, video games, etc. As used hereafter and in the appended claims, unless otherwise specifically denoted, the term “television program” will be used to refer expansively to all possible types of signals that can be seen or heard through a television receiver, including, but not limited to, broadcast television or audio programming (including cable and satellite signals), video games, computer data (e.g., a signal downloaded from the Internet) or recorded video programming from a PVR, video cassette recorder (VCR), a digital video disc (DVD) player or similar device.

The content advisory ratings are typically included in a television signal that includes both video and audio components and that is transmitted to the television receiver. For example, if the television signal is an analog signal, the Electronic Industries Association (EIA), which comprises individual organizations that together have agreed on certain data transmission standards, specifies that the content advisory rating data is included as part of the extended data services (XDS) of the vertical blanking interval (VBI) portion of the television signal. The VBI is a portion of a television signal that can carry information other than video or audio information.

The content advisory rating information is in the form of packets rather than continuous streams of data. For example, the packets can begin with a two-byte pair, followed by bytes which indicate the rating system in use and the specific rating for the current program or part of the program, and ending with a final byte indicating that the packet is no longer being transmitted. The number of bytes indicating the rating system and specific ratings can vary as best suits a particular application.

Using V-chip technology, then, a parent can program a television receiver to automatically accept or reject programs containing a particular level of violence, sexual content, or strong language, etc., as indicated by the content advisory rating packet. If the television receiver rejects a program, a blank or fuzzy image, or a splash screen could appear on the television receiver's screen instead of the rejected program. As previously mentioned, the content advisory rating can apply to all or part of a particular program. Thus, for example, a particular program could have different ratings associated with different scenes. This allows parents to block individual scenes of a program instead of the entire program using V-chip technology.

The transmission of digital television signals, however, typically uses an encoding and compression system for digital multimedia content defined by the Motion Pictures Expert Group (MPEG). MPEG-2 extends the basic MPEG system to provide compression support for television quality transmission of digital video. The content advisory rating information is preferably included in the user data section of the MPEG-2 transport data stream.

In many instances, a user desires to record a program that is shown on his or her television receiver. There are a variety of methods of recording a television program. One way of recording television programs is by using a videocassette recorder (VCR). However, videocassettes recordings are difficult to manage and index and are often poor in picture quality and resolution as compared to the quality of an original digital signal.

Personal video recorders (PVRs), on the other hand, use computer technology to digitally record a television program onto a non-volatile storage unit, such as a hard drive. PVRs can be stand-alone units or they can be integrated into STBs, IRDs satellite receivers, and other types of receivers.

The digital recordings on a PVR are often preferable to VCR recordings because they offer better picture quality and resolution. PVR recordings are also easy to manage and index. For example, one can instantly skip to particular scene of a television program that has been recorded on a PVR instead of fast-forwarding a VCR tape and guessing where on the tape the scene starts.

PVRs also have the ability to operate in trick play modes. Trick play modes allow a user to watch a television program in a non-linear fashion by replaying the recorded television program off the hard drive in some manner other than a normal, sequential replay. Trick play modes include, but are not limited to, slow motion, fast motion, reverse play, instant replay, jumping, pausing of live broadcast, and scanning.

The invocation of a trick play mode should preferably not bypass the V-chip parental controls. For example, a television program that has been recorded on a PVR and that has a content advisory rating that a parent deems inappropriate for his or her children should not be accessible for replay in either normal mode or a trick mode. However, because the content advisory rating information is in the form of packets, rather than in continuous streams of data, there is a possibility that the packets span more than one frame of the television program. Therefore, if a trick play mode skips frames, the content advisory rating data could be incomplete for a particular frame. This could result in the undesirable display of a frame or series of frames that should have been blocked.

Thus, there is a need in the art for a method and a system that assure the preservation and correct usage of content advisory rating information when a television program that has been recorded on a PVR is being replayed in trick play modes.

### SUMMARY OF THE INVENTION

In one of many possible embodiments, the present invention provides a personal video recorder which records and plays back a television program in a user-defined playback mode while preserving content advisory rating information. A decoder parses a digital transport stream comprising transport stream packets containing the television program and generates navigation data. A source of content advisory rating information corresponding to said television program is provided. This source of content advisory rating information may be within the digital transport stream. A non-volatile storage unit is used for saving each of the frames of the television program in a transport stream file and for saving the navigation data in a navigation data file. The navigation data includes pointers that point to a location of each of the frames of the television program in the transport stream file and content advisory rating information associated with each of the frames from the source of content advisory rating information. A processor executes an algorithm that processes the transport stream file according to the user-defined playback mode. Content advisory rating information that corresponds to frames that are to be shown in the user-defined playback mode is taken from the navigation data file and inserted in the video output signal.

Additional advantages and novel features of the invention will be set forth in the description which follows or may be learned by those skilled in the art through reading these materials or practicing the invention. The advantages of the invention may be achieved through the means recited in the attached claims.

### BRIEF DESCRIPTION OF THE DRAWINGS

The accompanying drawings illustrate various embodiments of the present invention and are a part of the specification. Together with the following description, the drawings demonstrate and explain the principles of the present invention. The illustrated embodiments are examples of the present invention and do not limit the scope of the invention.

FIG. 1 is an exemplary PVR configuration that can be used in conjunction with an embodiment of the present invention.

FIG. 2 shows an exemplary PVR television program recording process that can be used to implement an embodiment of the present invention.

FIG. 3 shows an exemplary PVR process that is capable of playing back a recorded television program and that can be used to implement an embodiment of the present invention.

FIG. 4 is a diagram of an exemplary MPEG encoder that can be used to implement an embodiment of the present invention.

FIG. 5 is a diagram of an exemplary transport stream packet that can be used to implement an embodiment of the present invention.

FIG. 6 is a diagram of an exemplary MPEG-2 transport stream demultiplexer that can be used to implement an embodiment of the present invention.

FIG. 7 illustrates an exemplary number of television program frames and the content advisory rating information packets associated with each of the frames.

FIG. 8 illustrates an embodiment of the present invention wherein the PVR television program recording process of FIG. 2 is shown with an additional capability of extracting the content advisory rating information from the vertical blanking interval data and including the content advisory rating information in the navigation data.

FIG. 9 illustrates an embodiment of the present invention wherein the PVR playback process of FIG. 3 is shown with an additional capability of extracting the content advisory rating information from the navigation data contained in the navigation presentation buffer and inserting the content advisory rating information into the analog video output of the video encoder according to an embodiment of the present invention.

Throughout the drawings, identical reference numbers designate similar, but not necessarily identical, elements.

### DETAILED DESCRIPTION OF THE PREFERRED EMBODIMENTS

The present invention provides a method and system whereby content advisory rating information is extracted from a television signal entering into a personal video recorder (PVR) and applied to every pointer in a navigation data file. Using the navigation file, the PVR can then correctly reinsert the content advisory rating information in a television program that has been recorded on the PVR and that is being played back in trick play modes. The navigation data file will be explained in more detail below. This method and system assure the preservation and correct usage of content advisory rating information when a television program that has been recorded on a PVR is being played back in trick play modes.

Using the drawings, the preferred embodiments of the present invention will now be explained.

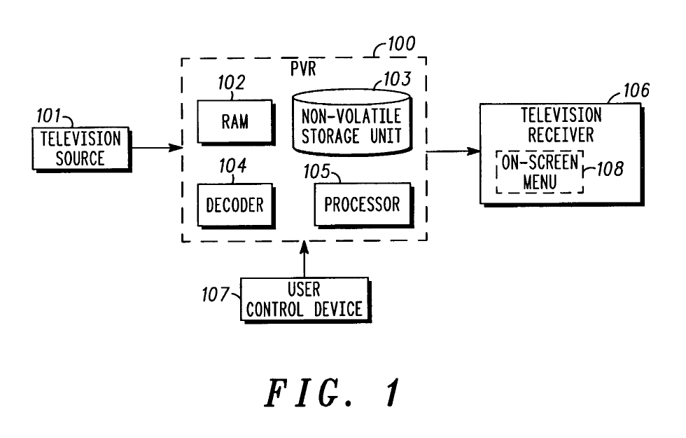

FIG. 1 is an exemplary PVR (100) configuration that can be used in conjunction with an embodiment of the present invention. It should be understood that while the invention is described using a stand-alone PVR (100) unit, the invention is not limited solely to stand-alone PVR units. For example, the PVR (100) of FIG. 1 can be integrated into a STB, IRD, satellite receiver, or other type of consumer electronic device.

Referring to FIG. 1, the PVR (100) receives a television signal from a television signal source (101). The television signal source (101) can be, but is not limited to, a cable television box, videocassette recorder (VCR), DVD player, Internet appliance, satellite dish, a video game system, or television antenna. The television signal contains the television program and may be encrypted. In which case, the PVR (100) is preferably capable of decrypting the encrypted television signal.

The PVR (100) preferably includes, but is not limited to, random access memory (RAM) (102), a non-volatile storage unit (103), a processor (105), and a decoder (104). Each of these components and the relationships between them will be described below.

The RAM (102) can be synchronous dynamic random access memory (SDRAM) or some other type of temporary storage unit. The RAM (102) has various uses in the PVR (100) including the temporary storage of the incoming television signal generated by the television signal source (101) and the temporary storage of an output television signal from the PVR (100) that is to be transmitted to a television receiver (106).

The non-volatile storage unit (103), as shown in FIG. 1, can be, but is not limited to, a hard disk drive or an optical disk drive, such as a digital versatile disc (DVD) drive. The non-volatile storage unit (103) preferably stores recorded television programs, custom settings for the PVR (100) as defined by a user, and other information that is associated with the PVR (100). The user can preferably program the PVR (100) to record a television program or set the custom settings with the use of a user control device (107).

The processor (105), as shown in FIG. 1, can be a central processing unit (CPU) or some other type of processor. The processor (105) performs a variety of functions in the PVR (100). For example, the processor (105) can be used to run algorithms that process the television signal according to a user-defined playback mode (e.g.; trick play modes).

The decoder (104), as shown in FIG. 1, is used to perform a variety of functions. For example, in an exemplary PVR (100) configuration, the decoder (104) parses the incoming television signal data stream, composed of a stream of bits, and extracts different portions of the data that are to be used in the PVR (100). These portions of data can include the bits that represent a particular frame, the bits that contain audio information, the bits that contain the content advisory rating information, and bits that contain other VBI based services that apply to a particular application.

In the exemplary configuration of FIG. 1, each set of bits that represents a different portion of the television signal starts with a specific bit pattern, referred to as a header, which allows the decoder (104) to distinguish between each set of bits. However, other integrated chips can parse the incoming television signal data stream, such as application specific integrated circuits (ASICs), digital signal processors (DSPs), and field-programmable gate arrays (FPGAs). Alternatively, the processor (105) can be programmed to replace the decoder (104) and parse the incoming television signal data stream.

The PVR (100) is connected to a television receiver (106). The television receiver (106), as shown in FIG. 1, receives a television signal from the PVR (100) that is to be displayed on the television receiver (106). The television receiver (106) can be, but is not limited to, a television set, video monitor, projector, or any other device capable of displaying the television program.

The television signal is composed of a number of frames, or individual pictures, that can be viewed in succession in normal viewing modes. However, in some trick mode operations, certain frames are skipped or are not viewed in succession. For example, if the PVR (100) is operating in fast motion mode, every other frame could be skipped and not seen. Another example is when the PVR (100) is operating in reverse play mode. In reverse play mode, the frames are shown in the reverse order that would be used under a normal viewing mode.

As shown in FIG. 1, the user control device (107) can be a separate unit from the PVR (100), such as a remote control unit. The user control unit (107) can also be or include a user input device that is integrated into the PVR (100) in the form of, for example, a control button pad located on the PVR (100). The user interface for the PVR (100) may include the user control device (107) and an interactive on-screen menu (108) that is displayed on a display of the PVR or, preferably, on the television receiver (106). The user control device (107) is used to send commands to the PVR (100), for example, to record a television program on the non-volatile storage unit (103), replay a television program that has been recorded on the non-volatile storage unit (103) in either normal mode or in trick play modes, block the display of television programs or scenes of television programs containing an undesirable content advisory rating, or perform other features as best serves a particular application.

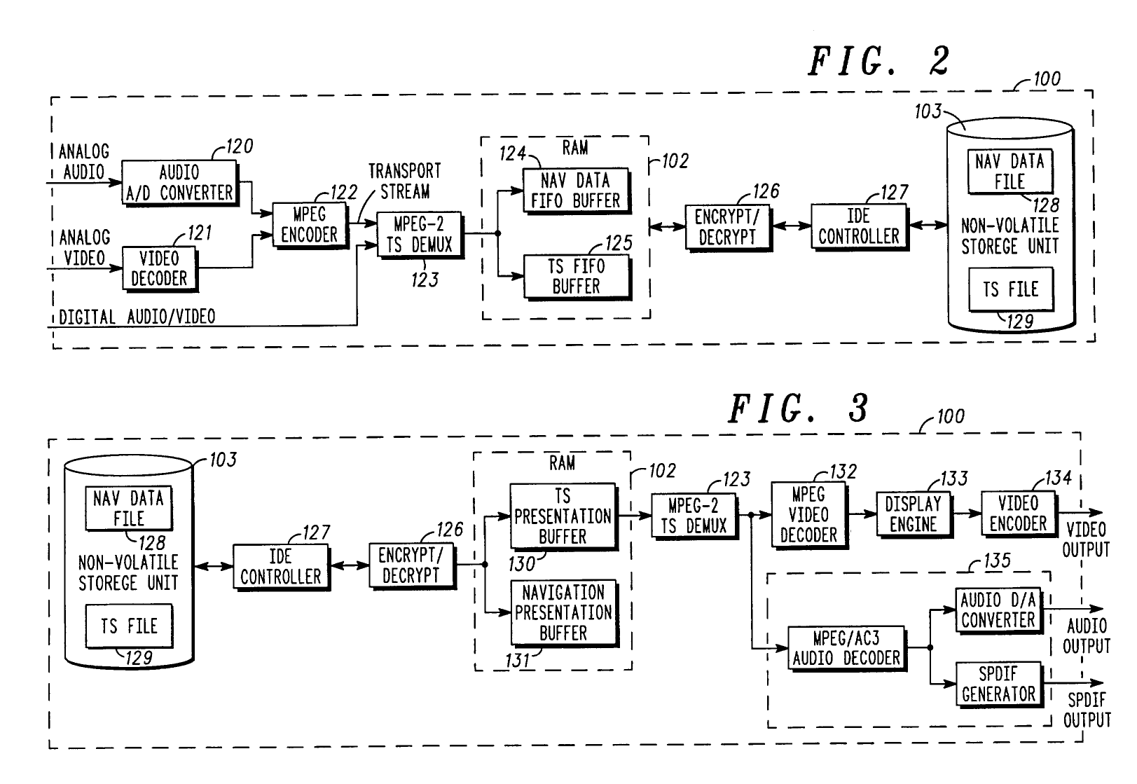

FIG. 2 shows an exemplary PVR (100) television program recording process that can be used to implement an embodiment of the present invention. As shown in FIG. 2, the PVR (100) preferably accepts either analog or digital television signals. Because PVRs (100) preferably process only digital television signals, the audio and video portions of analog television signal are preferably converted to a digital signal with an audio analog-to-digital converter (audio ADC) (120) and a video decoder (video DEC) (121), respectively. Both the audio ADC (120) and the video DEC (121) can be integrated circuits or a part of the decoder (104; FIG. 1). The video DEC (121) can be part of a Broadcom™ BCM7030 decoder, for example. The audio ADC (120) and video DEC (121) output continuous elementary streams of audio and video information.

As shown in FIG. 2, the audio and video signals from the ADC (120) and video DEC (121), respectively, are preferably combined into an MPEG digital signal using an MPEG encoder (122). The Broadcom™ BCM7040 Encoder ASIC is an exemplary MPEG encoder (122) that can be used to combine analog audio and video signals into an MPEG digital signal. The MPEG encoder (122) will be explained in more detail using the diagram of FIG. 4.

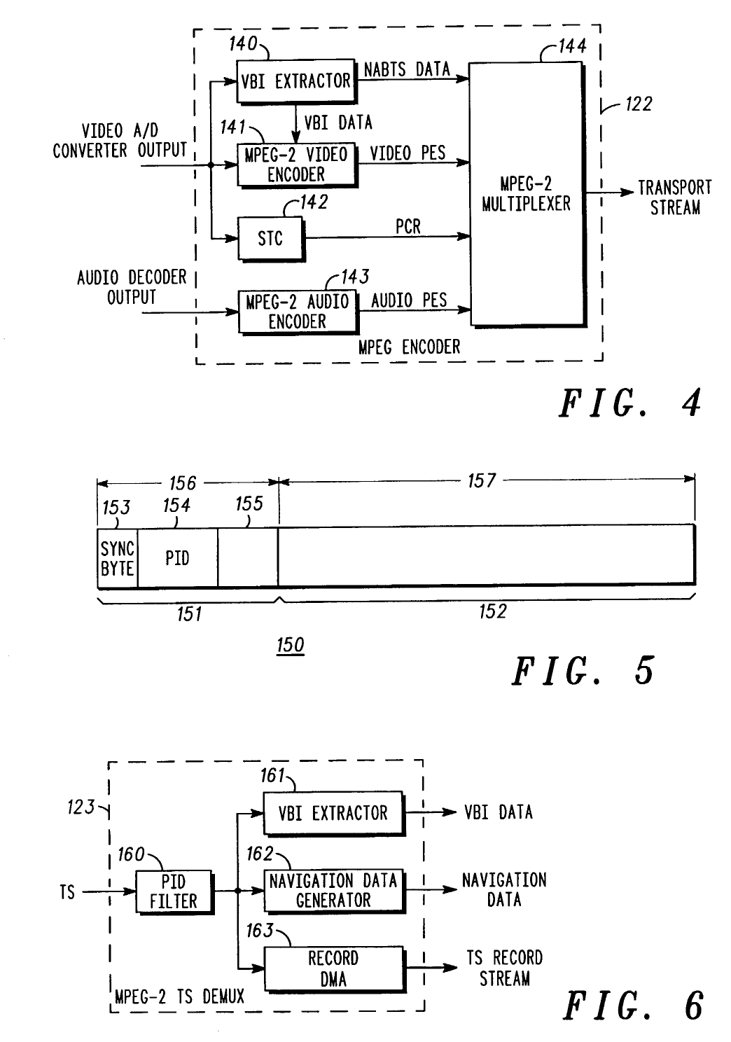

FIG. 4 is a diagram of an exemplary MPEG encoder (122) that can be used to implement an embodiment of the present invention. For practical purposes, the MPEG digital signal output of the MPEG encoder (122), referred to as a transport stream (TS), is output in the form of packets. Packets preferably consist of a series of bytes comprising a header and a payload. FIG. 5 is a diagram of an exemplary transport stream packet (150) that can be used to implement an embodiment of the present invention.

As shown in FIG. 5, the packet (150) is divided into a packet header (151) and a payload (152). An exemplary packet header (151) has a length (156) that is four bytes. Each byte contains eight bits. An exemplary payload (152) has a length (157) that is 184 bytes. However, the length (156) of the header (151) and the length (157) of the payload (152) portions of the packet (150) are arbitrary and vary as best serve a particular application.

The packet header (151) contains various fields that distinguish a particular packet from other packets. For example, the exemplary packet header (151) contains a sync byte (153) and a packet identification (PID) (154). The packet header (151) can also contain other information (155), such as error indicator bytes.

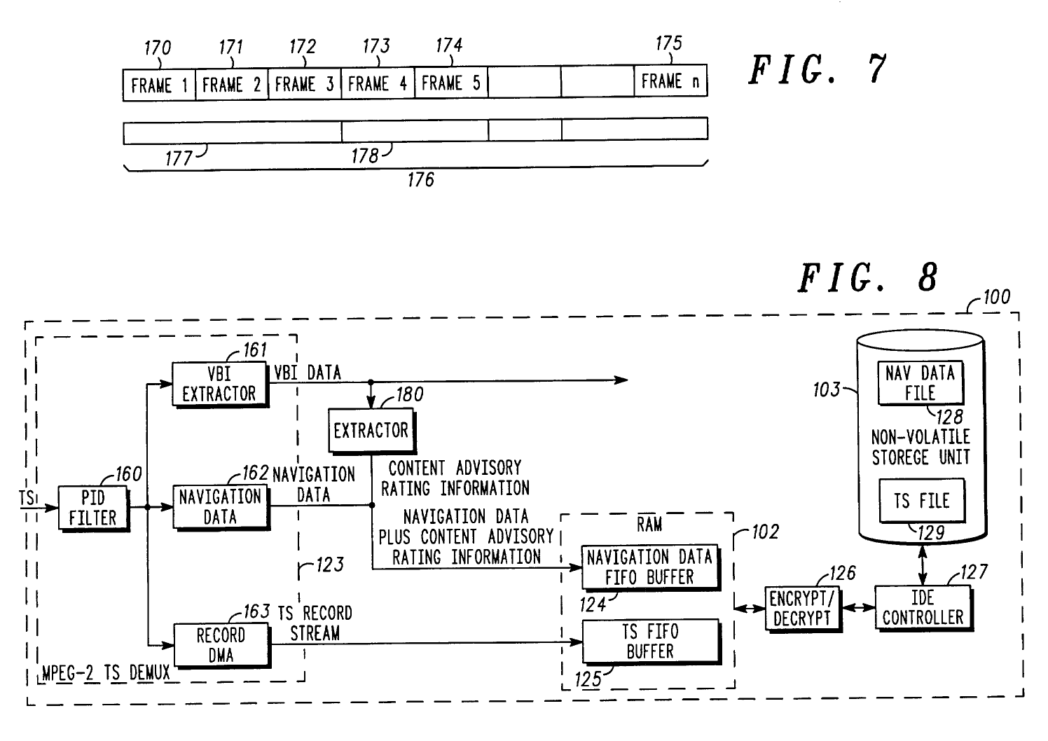

The PID (154) of FIG. 5 is a sequence of bits that is used by, for example, a MPEG-2 TS demultiplexer (123; FIG. 2) to distinguish between packets (150) containing different types of information and to collect packets multiplexed with other packets that pertain to a particular data structure or stream. For example, a packet containing video information contains a different PID value (154) than does a packet containing audio information. The MPEG-2 TS demultiplexer (123; FIG. 2) is preferably integrated into the decoder (104; FIG. 1) and will be explained in more detail below in connection with FIG. 6. The MPEG standard fixes the PID (154) length to be 13 bits. However, the length of the PID (154) could vary in other applications.

Thus, in a given transport stream, all the packets (150) belonging to a given elementary stream, such as the video stream, will have the same PID (154). The MPEG-2 demultiplexer (123; FIG. 2) can then easily select all data for a given elementary stream simply by accepting only the packets (150) with the correct PID (154).

Referring again to FIG. 4, an MPEG-2 video encoder function (141), that is preferably integrated into the MPEG encoder (122), accepts the output signal from the video DEC (121; FIG. 2), encodes this signal into an MPEG-2 format, and outputs a video packetized elementary stream (Video PES). Likewise, an MPEG-2 audio encoder function (143) that is preferably integrated into the MPEG encoder (122) accepts the audio ADC (120; FIG. 2) output signal, encodes this signal into an MPEG-2 format, and outputs an audio PES (audio PES).

As shown in FIG. 4, the MPEG encoder (122) also preferably contains a VBI extractor function (140) that extracts the VBI data from the video DEC (121; FIG. 2) output signal. The VBI data includes, but is not limited to, the content advisory rating information. As indicated above, the content advisory rating information is typically included in the XDS portion of the VBI data. The content advisory rating information is preferably contained in the VBI of line 21 or line 284 of the television signal. However, the content advisory rating information can be contained in the VBI of a line other than line 21 or 284 of the television signal.

After the VBI extractor (140) has extracted the VBI data, the VBI data is preferably inserted into the User Data section of the MPEG stream by the MPEG-2 video encoder (141), as shown in FIG. 4. However, the VBI data does not have to be inserted into the User Data section of the MPEG stream. In another embodiment of the present invention, the VBI data that is extracted by the VBI extractor (140) is assigned its own PID (154; FIG. 5).

The VBI extractor (140) can also output North American Basic Teletext Specification (NABTS) data as well. The MPEG encoder (122) also preferably includes a system time clock (STC) function (142) that generates a Program Clock Reference (PCR) signal. Both the NABTS data and PCR data are preferably in packetized form. The MPEG encoder (122) can also extract other data as best serves a particular application. However, the output of NABTS data and PCR data is not necessary to implement the embodiments of the present invention.

As shown in FIG. 4, the MPEG encoder (122) preferably includes an MPEG-2 Multiplexer (144). The MPEG-2 Multiplexer (144) multiplexes the video PES, audio PES, NABTS data, PCR data, and any other data that the MPEG encoder (122) extracts into the transport stream.

Returning to FIG. 2, the transport stream output from the MPEG encoder (122) is input into an MPEG-2 TS Demultiplexer (123). As shown in FIG. 2, the MPEG-2 TS Demultiplexer (123) can also preferably accept a digital signal that is already in MPEG-2 format. The MPEG-2 TS Demultiplexer (123) will now be explained in more detail using the diagram of FIG. 6.

FIG. 6 is a diagram of an exemplary MPEG-2 TS demultiplexer (123) that can be used to implement an embodiment of the present invention. The Broadcom™ BCM7030 decoder is an exemplary, but not exclusive, decoder that can be used to implement the MPEG-2 TS demultiplexer (123). It should be noted, however, that the functions performed by the MPEG-2 TS Demultiplexer (123) can also be performed by other types of decoders or by the processor (105; FIG. 1).

As shown in FIG. 6, the MPEG-2 TS demultiplexer (123) comprises PID filters (160) that sort and select the incoming transport stream packets (150; FIG. 6) based on their PIDs (154; FIG. 6). The different components of the transport stream can then be divided into separate streams and particular data that is needed by various components of the PVR (100; FIG. 1) can be extracted. For example, the packets containing VBI data can be identified by the PID filters (160) and, as FIG. 6 shows, the VBI data can be extracted from the packets containing VBI data with a VBI extractor function (161). Another example is that the packets containing the television program frame information can be identified by the PID filters (160) and the data comprising the stream that is to be recorded can be extracted with a record direct memory access (DMA) function (163).

The MPEG-2 TS demultiplexer (123), as shown in FIG. 6, preferably generates navigation data with a navigation data generating function (162). The navigation data is comprised of a list of pointers, or indexes. Each pointer in the navigation data points to a specific frame header in the transport stream that is to be recorded. There is preferably one pointer for each frame of the television program that is to be recorded.

Returning to FIG. 2, the navigation data and the transport stream outputs from the MPEG-2 TS demultiplexer (123) are stored in first-in first-out (FIFO) buffers (124, 125) in the RAM (102). They can then be encrypted by an encrypt/decrypt function (126). The encrypt/decrypt function (126) is preferably integrated into the decoder (104; FIG. 1). After the navigation data and transport stream are encrypted, they are respectively saved in a navigation data file (128) and TS file (129) on the non-volatile storage unit (103). An integrated development environment (IDE) controller (127) facilitates the storage of the data on the non-volatile storage unit (103).

FIG. 3 shows an exemplary PVR (100) process that is capable of playing back a recorded television program and that can be used to implement an embodiment of the present invention. A television program can be replayed if there is a TS file (129) and a corresponding navigation data file (128) saved in the non-volatile storage unit (103), as shown in FIG. 3.

The navigation data is loaded into a navigation presentation buffer (131) that is resident in the RAM (102). Depending on the particular playback mode (e.g.; normal or trick play) that is chosen by the user, the processor (105; FIG. 1), decoder (104; FIG. 1), or other PVR (100; FIG. 1) device uses an algorithm to generate appropriate IDE controller (127) reads to the non-volatile storage unit (103) and loads a presentation transport stream from the TS file (129) into a TS presentation buffer (130) in the RAM (102). The presentation transport stream includes particular frames in the TS file (129) that are to be shown in the playback of the television program in accordance with the playback mode selected, normal or trick. The algorithm uses the pointers in the navigation presentation buffer (131) to select the particular frames in the TS file (129) that are to be included in the presentation transport stream.

The contents of the TS presentation buffer (130) are then input into the MPEG-2 TS demultiplexer (123). The MPEG-2 TS demultiplexer (123) can be the same demultiplexer that is used in the record process and performs the same function. However, instead of outputting a TS record stream as it does in the record process, the MPEG-2 TS demultiplexer (123) outputs a transport stream that will be decoded and converted to an analog signal that can be displayed on the television receiver (106; FIG. 1). However, if the television receiver (106; FIG. 1) is capable of displaying a digital MPEG signal, the conversion of the transport stream to analog is not necessary.

As shown in FIG. 3, the video portion of the transport stream that is in MPEG format is decoded by an MPEG video decoder (132). The MPEG video decoder (132) is preferably integrated into the decoder (104; FIG. 1) and outputs a digital signal. The output of the MPEG video decoder (132) is preferably input to a display engine (133) and then into a video encoder (134). The video encoder (134) performs the final conversion of the video signal that is to be displayed on the television receiver (106; FIG. 1) and outputs an analog video signal that can be displayed on the television receiver (106; FIG. 1). The content advisory rating information corresponding to the frames that are to be displayed on the television receiver (106; FIG. 1) is preferably inserted into the analog video signal with the video encoder (134). This process will be explained in connection with FIG. 9.

As shown in FIG. 3, various components (135) convert the audio portion of the transport stream into an analog format that is recognized by the television receiver (106; FIG. 1). The conversion of the audio portion of the transport stream is not essential to implement the present invention.

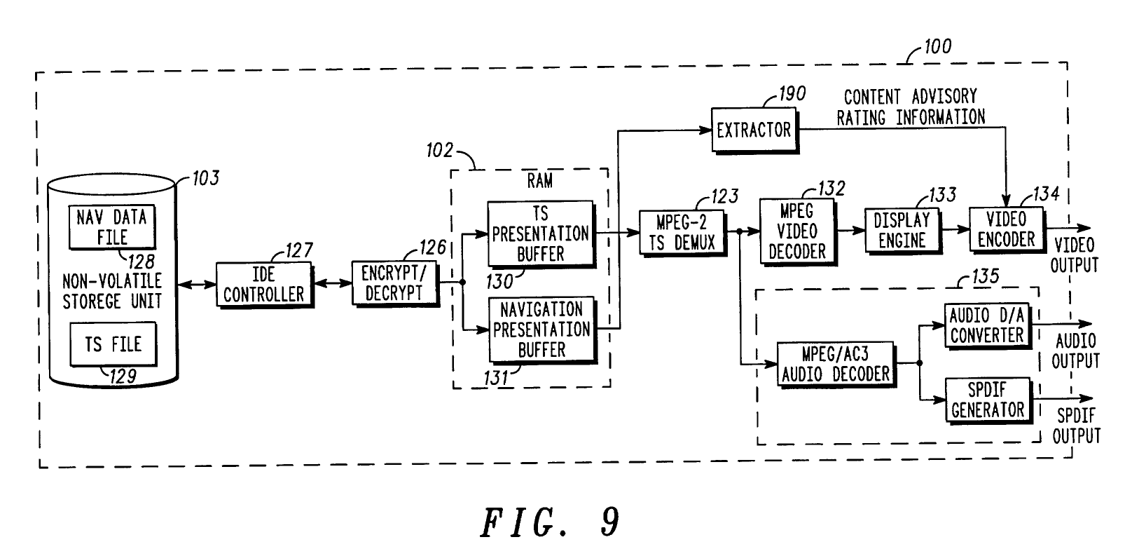

FIG. 7 illustrates an exemplary number, n, of television program frames (170-175) and the content advisory rating information packets (176) associated with each of the frames (170-175). FIG. 7 will be used in connection with FIG. 8 and FIG. 9 to illustrate various embodiments of the present invention.

As shown in FIG. 7, the television program preferably consists of n frames (170-175). The frames (170-175) can be shown on the television receiver (106; FIG. 1) in sequential order if the PVR (100; FIG. 1) is operating in normal viewing mode. The frames (170-175) can also be shown in other orders, such as is the case when the PVR (100; FIG. 1) is operating in trick play modes. For example, in an exemplary fast forward trick play mode, frame 1 (170) is shown and then frame 5 (175) can be shown. Frames 2 through 4 (171-173) are not shown in this exemplary fast forward trick play mode.

As FIG. 7 shows, the content advisory rating information packets (176) may span different numbers of frames (170-175). In the setup of FIG. 7, for example, a content advisory rating information packet (177) spans frame 1 (170) through frame 3 (172) and another content advisory rating information packet (178) spans frame 4 (173) through frame 5 (174). In other words, the content rating advisory in a particular packet applies to a number of the frames.

FIG. 8 illustrates an embodiment of the present invention. More specifically, the PVR (100) television program recording process of FIG. 2 is shown with an expanded view of the MPEG-2 TS demultiplexer (123). As shown in FIG. 8, the content advisory rating information is extracted with an extractor function (180) from the VBI data. The extractor function (180) then outputs the content advisory rating information, in combination with the navigation data from the navigation data function (162), to the navigation data FIFO buffer (124). The exact method of implementing the extractor function (180), which extracts the content advisory rating information from the VBI data, can vary as best serves a particular application and is easily performed by one who is skilled in the art. The decoder (104; FIG. 1), processor (105; FIG. 1), or some other device in the PVR (100) can perform the extraction.

Thus, each given pointer in the navigation data preferably includes the content advisory rating information for the frame associated with the given pointer. For example, one pointer points to frame 1 (170; FIG. 7) and contains the content advisory rating information (177; FIG. 7) that is associated with frame 1 (170; FIG. 7). Likewise, another pointer in the navigation data points to frame 5 (174; FIG. 7) and contains the content advisory rating information (178; FIG. 8) that is associated with frame 5 (174; FIG. 7). The combined information, instead of just the navigation data, is then saved in the navigation data file (128) on the non-volatile storage unit (103).

FIG. 9 illustrates another embodiment of the present invention. More specifically, the PVR (100) of FIG. 3 is shown with an additional capability of extracting with an extractor function (190) the content advisory rating information from the navigation data contained in the navigation presentation buffer (131) and inserting the particular content advisory rating information that corresponds to the frames that are to be shown by the television receiver (106; FIG. 1) into the analog video output of the video encoder (134). The insertion of content advisory rating information into the analog video output of the video encoder (134) allows the preservation of a television program's content advisory rating information even when the television program is being played back in a trick play mode.

The extraction of the content advisory rating information from the navigation data and the insertion of the content advisory rating information into the analog video output of the video encoder (134) is preferably performed by the processor (105; FIG. 1). At the same time that the processor (105; FIG. 1) generates the appropriate IDE controller (127) reads to the non-volatile storage unit (103) and loads the presentation transport stream from the TS file (129) into the TS presentation buffer (130) in the RAM (102), as explained in connection with FIG. 3, the processor (105; FIG. 1) preferably extracts the content advisory rating information that is associated with the frames in the presentation transport stream from the navigation data with the extractor function (190). This extracted content advisory rating information is then sent to the video encoder (134) by the processor (105; FIG. 1) or by a function in decoder (104; FIG. 1) and is inserted into the analog video output of the video encoder (134) in a manner such that the content advisory rating information is correctly associated with the frames that are shown by the television receiver (106; FIG. 1). The specific method of extraction and insertion will vary as best serves a particular application and can be easily performed by one skilled in the art. Although the extraction of the content advisory rating information from the navigation data and the insertion of the content advisory rating information into the analog video output of the video encoder (134) is preferably performed by the processor (105; FIG. 1), the decoder (104; FIG. 1) or some other device in the PVR (100) can also be used to perform the extraction and insertion of the content advisory rating information.

An advantage of including the content advisory rating information in the navigation data file (128) is that it allows the television program to be replayed in any trick mode without incorrect or missing content advisory rating information. This is because the content advisory rating information for each frame that is to be displayed in any trick mode can be inserted in the analog video output of the video encoder (134), as shown in FIG. 9.

Another embodiment of the present invention entails the replacement of content advisory rating information associated with a particular television program that has been recorded by the PVR (100; FIG. 1) with updated or different content advisory rating information. The different content advisory rating information could originate from another rating system, such as the electronic program guide (EPG) rating system, for example. The different content advisory rating information is preferably inserted in the analog video output of the video encoder (134; FIG. 9) using a method similar to the method explained in connection with FIG. 9.

Another embodiment of the present invention entails the insertion of content advisory rating information into the analog video output of the video encoder (134; FIG. 9) for a recorded television program that originally lacks content advisory rating information. The content advisory rating information can originate from the EPG rating system or from some other rating system. The method of inserting the content advisory rating information is similar to the method explained in connection with FIG. 9.

Another embodiment of the present invention entails the inclusion of scene-by-scene content advisory ratings from an augmented database. For example, the original television signal for a particular television program might include a single rating for the entire television program but an augmented database could include scene-by-scene content advisory ratings for the same television program which could be inserted into the analog output of the video encoder (134; FIG. 9) during the playback of the television program. This could allow a “restricted” (R-rated) television program that is stored on the non-volatile storage unit (103; FIG. 1) to be played back as a “parental guidance suggested” (PG-rated) version. The augmented database can be stored on the non-volatile storage unit (103; FIG. 1) of the PVR (100; FIG. 1), for example, and inserted into the analog video output of the video encoder (134; FIG. 9) using a method similar to the method explained in connection with FIG. 9.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best illustrate the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A method of preserving content advisory rating information for a television program that is recorded on a personal video recorder, said method comprising, when said television program is to be played back in a trick mode, inserting said content advisory rating information in a video output signal of said personal video recorder, said television program comprising a number of frames with a content advisory rating corresponding to each of said frames being inserted by said personal video recorder into said video output signal in association with that frame.

2. The method of claim 1, further comprising:
parsing a digital transport stream and extracting said content advisory rating information from said transport stream, said transport stream comprising transport stream packets;
saving each of said frames of said television program in a transport stream file on a non-volatile storage unit of said personal video recorder;
generating a navigation data file of navigation data on said non-volatile storage unit of said personal video recorder, said navigation data comprising pointers that point to a location of each of said frames in said transport stream file; and
saving said content advisory rating information in said navigation data file, said content advisory rating information being associated with said pointers;
wherein upon playback of said television program, said content advisory rating information that corresponds to each frame that is to be shown in said playback is extracted from said navigation data in said navigation data file and inserted in said analog video output signal of said personal video recorder.

3. The method of claim 2, further comprising preserving content advisory rating information when said personal video recorder is operating in a trick play mode.

4. The method of claim 2, further comprising generating said transport stream with a Motion Pictures Expert Group encoder, said encoder having an analog video signal input.

5. The method of claim 4, further comprising:
extracting vertical blanking interval information from said analog video signal with said encoder, said vertical blanking interval information containing said content advisory rating information; and
including said vertical blanking interval data in packets of said transport stream.

6. The method of claim 5, further comprising assigning a packet identification value to said packets containing said vertical blanking interval data.

7. The method of claim 2, further comprising, with packet identification filters, sorting said transport stream packets into separate streams based on a packet identification value of each packet.

8. The method of claim 2, further comprising extracting said content advisory rating information from said transport stream.

9. The method of claim 2, further comprising temporarily storing said navigation data and said transport stream that are to be saved on said non-volatile storage unit in buffers, said buffers being a part of a random access memory.

10. The method of claim 2, further comprising loading said navigation data from said navigation data file into a navigation presentation buffer that is resident in a random access memory.

11. The method of claim 11, further comprising using an algorithm to generate integrated development environment controller reads to said non-volatile storage unit and loading a presentation transport stream into a transport stream presentation buffer that is resident in said random access memory, said algorithm being chosen based on a user-defined playback mode.

12. A personal video recorder for recording and playing back a television program in a user-defined playback mode with content advisory rating information, said television program comprising a number of frames, said recorder comprising:
a decoder for parsing a digital transport stream comprising transport stream packets, extracting said content advisory rating information from said transport stream, and generating navigation data;
a non-volatile storage unit for saving each of said frames of said television program in a transport stream file and for saving said navigation data in a navigation data file, said navigation data comprising pointers that point to a location of each of said frames of said television program in said transport stream file and content advisory rating information associated with each of said frames; and
a processor for executing an algorithm that processes said transport stream file according to said user-defined playback mode;
wherein said content advisory rating information that corresponds to frames that are to be shown in said user-defined playback mode is taken from said navigation data file and inserted in said video output signal.

13. The recorder of claim 12, further comprising a connection to a television receiver for displaying said video output signal of said personal video recorder in accordance with said content advisory rating information.

14. The recorder of claim 12, wherein said processor is programmed to provide playback of said television program in one or more trick play modes, said user-defined playback mode being a trick play mode.

15. The recorder of claim 12, wherein said recorder further comprises a Motion Pictures Expert Group encoder for generating said transport stream, said encoder having an analog video signal input.

16. The recorder of claim 15, wherein said encoder further comprises a vertical blanking interval extractor function for extracting vertical blanking interval information from said analog video signal, said vertical blanking interval information said content advisory rating information.

17. The recorder of claim 16, wherein said encoder inserts said vertical blanking interval data into packets of said transport stream.

18. The recorder of claim 17, wherein said encoder assigns a packet identification to said packets containing said vertical blanking interval data.

19. The recorder of claim 12, wherein said decoder comprises packet identification filters for sorting said transport stream packets into separate streams based on packet identifications of said packets.

20. The recorder of claim 19, wherein said decoder further comprises a vertical blanking interval extractor function that extracts vertical blanking interval data from said transport stream.

21. The recorder of claim 20, wherein said decoder further comprises an extractor function that extracts said content advisory rating information from said vertical blanking interval data.

22. The recorder of claim 12, wherein said recorder further comprises random access memory containing buffers for temporarily storing said navigation data and said transport stream that are to be saved on said non-volatile storage unit.

23. The recorder of claim 22, wherein said random access memory further comprises a navigation presentation buffer for temporarily storing navigation data from said navigation data file after said navigation data file has already been saved on said non-volatile storage unit.

24. The recorder of claim 12, wherein said recorder further comprises an integrated development environment controller for reading data on said non-volatile storage unit.

25. The recorder of claim 12, wherein said processor generates integrated development environment controller reads to said non-volatile storage unit and loads a presentation transport stream into a transport stream presentation buffer that is resident in said random access memory, said presentation transport stream comprising at least one frame that is to be shown in said user-defined playback mode.

26. The recorder of claim 12, wherein said non-volatile storage unit comprises a hard disk drive.

27. The recorder of claim 12, wherein said non-volatile storage unit comprises an optical disc drive.

28. The recorder of claim 12, wherein said decoder is integrated into an application specific integrated circuit.

29. A personal video recorder for recording and playing back a television program in a user-defined playback mode with content advisory rating information, said television program comprising a number of frames, said recorder comprising:
a decoder for parsing a digital transport stream comprising transport stream packets containing said television program and generating navigation data;
a source of content advisory rating information corresponding to said television program;
a non-volatile storage unit for saving each of said frames of said television program in a transport stream file and for saving said navigation data in a navigation data file, said navigation data comprising pointers that point to a location of each of said frames of said television program in said transport stream file and content advisory rating information associated with each of said frames from said source of content advisory rating information; and
a processor for executing an algorithm that processes said transport stream file according to said user-defined playback mode;
wherein said content advisory rating information that corresponds to frames that are to be shown in said user-defined playback mode is taken from said navigation data file and inserted in said video output signal.

30. The recorder of claim 31, wherein said source of content advisory rating information is a database accessible to said recorder.

31. The recorder of claim 31, wherein said source of content advisory rating information comprises an electronic program guide rating system received by said recorder.

32. The recorder of claim 31, wherein said television program comprises original content advisory rating information when received by recorder, and said original content advisory rating information is replaced with content advisory rating information from said source of content advisory rating information.

33. A system for preserving content advisory rating information for a television program that is recorded on a personal video recorder, said system comprising:
means for collecting said content advisory rating information in association with each of a number of frames of said television program; and
means for inserting said content advisory rating information in a video output signal of said personal video recorder, wherein content advisory rating corresponding to said frames is inserted by said personal video recorder into said video output signal.

34. The system of claim 35, further comprising:
means for parsing a digital transport stream and extracting said content advisory rating information from said transport stream, said transport stream comprising transport stream packets;
means for saving each of said frames of said television program in a transport stream file on a non-volatile storage unit of said personal video recorder;
means for generating a navigation data file of navigation data on said non-volatile storage unit of said personal video recorder, said navigation data comprising pointers that point to a location of each of said frames in said transport stream file;
means for saving said content advisory rating information in said navigation data file, said content advisory rating information being associated with said pointers; and
means for extracting said content advisory rating information from said navigation data file and inserting content advisory rating information that corresponds to frames that are to be shown in a user-controlled playback in said analog video output signal of said personal video recorder.
